(19) United States
(12) Patent Application Publication
(10) Pub. No.: US 2007/0152501 A1
(43) Pub. Date: Jul. 5, 2007

(54) Systems and methods for braking in a motor vehicle

(75) Inventors: Georg Eichner, Ismaning (DE); Alexander Leitner, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/652,518

(22) Filed: Jan. 12, 2007

Related U.S. Application Data
(63) Continuation of application No. PCT/EP05/07038, filed on Jun. 30, 2005.

(30) Foreign Application Priority Data
Jul. 15, 2004 (DE) 10 2004 034 068.4

(51) Int. Cl. B60T 8/62

(52) U.S. Cl. 303/191; 303/189

(57) ABSTRACT

The invention relates to a brake system and a process for braking for a motor vehicle. A brake system for a motor vehicle is provided. The system comprises a brake actuation device for wheel brakes formed as friction brakes. A control device is provided where, in a braked transition from driving to standing as of a certain low speed or from standing to driving up to a certain low speed, the control device actuates the wheel brakes at different times from one another, or energizes the wheel brakes at different times from one another with increasing actuation force, or releases the wheel brakes at different times from one another, or energizes the wheel brakes at different times from one another with decreasing actuation force.

### CROSS REFERENCE TO RELATED APPLICATIONS

This application is a continuation of PCT International Application No. PCT/EP2005/007038, filed Jun. 30, 2005, which claims priority under 35 U.S.C. § 119 to German Patent Application No. 10 2004 034 068.4, filed Jul. 15, 2004, the entire disclosures of which are herein expressly incorporated by reference.

### BACKGROUND AND SUMMARY OF THE INVENTION

The present invention relates generally to motor vehicles and, more particularly, to vehicle braking systems and methods.

In motor vehicles that start or stop on a hill, groaning can occur as a consequence of the downhill-slope force, releasing the brake, and/or braking to a stop at low speeds of the motor vehicle. The groaning is often caused by vibrations in the wheel brake, chassis, and body.

Stick-slip effects bring the wheel brake into a rigid body vibration, which results in the spring strut being excited on the first order of bending. Via the chassis even the body can be excited and assume a so-called loudspeaker function. The speed at which such groaning occurs lies essentially between 0 and 10 km/h.

In automatic vehicles, this groaning additionally arises, depending on the level of the drive moment, at standstill, e.g., at traffic lights, on releasing the brake, or in the transition between adhesion and sliding. The groaning can also be triggered intentionally by the driver by choosing the appropriate brake release pressure.

Brake groaning occurs at both the front axle and the rear axle in proportion to the braking force to be transferred. If it is noticeable in the vehicle, this can be perceived as irritating.

In known vehicle brake systems (particularly those with disk brakes and in particular upon releasing the brakes with drive moment present or upon braking the motor vehicle at high speeds), a so-called brake groaning can occur immediately before stopping. This is described in WO 98/48193, where also a measure for avoiding brake groaning is presented. This measure involves disposing brake shoes on both sides of the brake disk and having areas of reduced layer thickness of the friction lining so that these areas are not disposed so as to be mirror-symmetric.

An aspect of the present invention involves presenting additional measures for avoiding brake groaning for a brake system for a motor vehicle, where the brake system comprises at least one brake actuation device for wheel brakes formed as friction brakes.

Consistent with the present invention, a brake system for a motor vehicle is provided. The brake system comprises at least one brake actuation device for wheel brakes formed as friction brakes. A control device is provided where, in a braked transition from driving to standing as of a certain low speed or from standing to driving up to a certain low speed, the control device actuates the wheel brakes at different times from one another, or energizes the wheel brakes at different times from one another with increasing actuation force, or releases the wheel brakes at different times from one another, or energizes the wheel brakes at different times from one another with decreasing actuation force.

With such a control device, a capability for operating the brake system and counteracting the described groaning can advantageously be added with very little effort and at low cost. In so doing, the certain low speed may lie between 0 and 10 km/h, in particular between 0 and 6 km/h.

Consistent with the present invention, a process for braking a motor vehicle is provided. In a braked transition from driving to standing as of a certain low speed or from standing to driving up to a certain low speed, wheel brakes are actuated at different times from one another, or are energized at different times from one another with increasing actuation force, or are released at different times from one another, or are energized at different times from one another with decreasing actuation force. Through this process, brake groaning can advantageously be counteracted with very little effort and at low cost during braking or starting. In so doing, the certain low speed should also lie between 0 and 10 km/h, in particular between 0 and 6 km/h.

Consistent with an implementation of the present invention, the wheel brakes, during driving within the range of low speed and when standing still, are controlled via the brake actuation device so that in their actuation in the direction of increasing the braking force an essentially constant braking force is generated by each wheel brake. This constant braking force makes possible braking to a stop of the motor vehicle and also that, in their actuation in the direction of decreasing the braking force, each wheel brake is completely released and no more braking force is generated.

Releasing the wheel brakes and braking to a stop in the relevant speed range (0 to 10 km/h) and braking pressure range (0 to 20 bar) not simultaneously but rather at different times from one another, one after another, depending on the coefficient of friction of the lining has an advantage that the driver can achieve only one of two states. The first state includes standing of the vehicle with the brakes closed, and the second state includes rolling of the vehicle with the brakes open. Advantageously, for a rather long period of time it is thus no longer possible to influence the speed and braking pressure so that groaning results in the range relevant to groaning, i.e., precisely at the transition from adhering to sliding of the brake linings on the brake disk.

In so doing, it is alternatively possible according to the invention that the wheel brakes are each, individually or in pairs, actuated at different times from one another, or are energized at different times from one another with increasing actuation force, or are released at different times from one another, or are energized at different times from one another with decreasing actuation force.

In particular, the brake system for a motor vehicle according to the invention can comprise at least one anti-locking braking system which forms the control device for the application of the actuation force at different times. Furthermore, the actuation force for the wheel brakes can be applied pneumatically, hydraulically, or by actuators driven by an electric motor.

Other objects, advantages and novel features of the present invention will become apparent from the following detailed description of the invention when considered in conjunction with the accompanying drawings.

### BRIEF DESCRIPTION OF THE DRAWINGS

The invention is explained in detail below with reference to the attached drawings. In the drawings:

FIG. 1 is a block diagram of an exemplary implementation of a brake system according to the invention; and

FIG. 2 is a braking pressure/time diagram of a brake release process with a brake system according to the invention.

### DETAILED DESCRIPTION OF THE DRAWINGS

The following description refers to the accompanying drawings. The implementations set forth in the following description do not represent all implementations consistent with the claimed invention. Instead, they are merely some examples of implementations consistent with the invention. Other implementations may be used and structural and procedural changes may be made without departing from the scope of present invention.

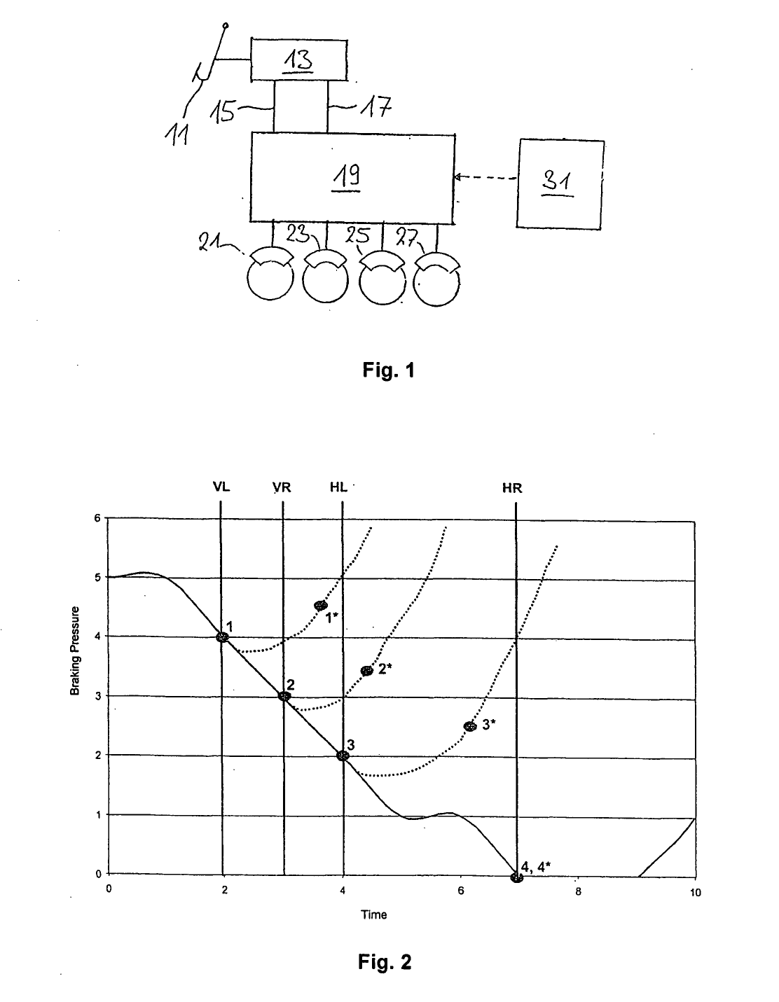

FIG. 1 shows a brake system, for a vehicle not represented in more detail, with friction brakes for each wheel. The brake system is designed in a manner known as a hydraulic friction brake system or electrohydraulic friction brake system. The brake system has a main brake cylinder 13 mechanically actuable by a brake actuation device formed as a brake pedal 11. The main brake cylinder 13 is hydraulically connected via a first output line 15 of a first brake circuit and a second output line 17 of a second brake circuit to a hydraulic unit 19. The four wheel brake devices 21, 23, 25, 27 of the vehicle are connected to the hydraulic unit 19 so that the braking pressure in the wheel brake devices 21, 23, 25, 27 can be set individually via the hydraulic unit 19.

Particular implementation and design details of the hydraulic unit 19 may be known to those skilled in the art from hydraulic or electrohydraulic brake systems customary in modern vehicles. Such brake systems comprise driving stability controls (for example, ESP), anti-lock braking controls (ABS), or automatic slip controls (ASR). Thus, the particular design will not be explained further at this point.

Control apparatus in the control device 31 controls the wheel brake devices 21, 23, 25, 27 so that, in a braked transition from driving to standing as of a certain low speed or from standing to driving up to a certain low speed, the wheel brakes are: (1) actuated at different times from one another; (2) energized at different times from one another with increasing actuation force; (3) released at different times from one another; or (4) energized at different times from one another with decreasing actuation force.

FIG. 2 shows, as an example, a braking pressure/time diagram starting from a vehicle braked to a stop on all four wheels, where the driver of said vehicle slowly releases the wheel brakes via the brake actuation device. With this, the braking pressure (bar) drops over the time (s) at all four wheels until, on reaching the point 1, the control device 31 lowers the braking pressure to zero at the wheel brake at the left front VL, the wheel brake at the left front VL therefore being released completely after 2 seconds. Further reduction of the braking pressure via the brake actuation device causes, in sequence, at point 2 the sudden lowering of the braking pressure at the wheel brake at the right front VR after 3 seconds, and at point 3 the sudden lowering of the braking pressure at the wheel brake at the back left HL after 4 seconds. At point 4, the braking pressure level then reaches zero after 7 seconds by lowering of the braking pressure at the wheel brake at the right back HR. If this were done, as here, not mandatorily, by releasing of the brake actuation device, the control device 31 would also release it after 7 seconds by sudden lowering of the braking pressure at the wheel brake at the right back HR.

In so doing, time and pressure threshold values for the points 1 to 4, just as the wheel brake sequence in the control device 31, can be set so as to be variable, e.g., via parameters. The function is active until either the braking pressure is zero or the highest pressure threshold that can be set is exceeded, when by subsequent increase in braking pressure via the brake actuation device the process runs again in reverse, as represented by the braking pressure/time curve drawn with a dashed line. The points 1*, 2*, 3*, and 4* marked with a star indicate the times at which the braking pressure, starting from zero, is once again suddenly set in the individual wheel brakes by the control device 31, when the driver once again increases, via the brake actuation device, the braking pressure corresponding to the braking pressure/time curve drawn with a dashed line. Thus, at point 1*, a pressure buildup from zero to approximately 4.5 bar takes place at the wheel brake at the left front VL. At point 2*, a pressure buildup from zero to approximately 3.4 bar takes place at the wheel brake at the right front VR. At point 3*, a pressure buildup from zero to approximately 2.5 bar takes place at the wheel brake at the left back HL. Depending on the time at which the driver reverses the process using the brake actuation device, the wheel brakes previously made pressureless are engaged once again at different times from one another in reverse order.

The individual pressure curves and values, time intervals, and the order of the switching on and off of the individual wheel brakes can be varied and the invention is not restricted to certain values, curves, and orders. Rather, the invention is intended to include all suitable procedures which include varying the braking pressure with respect to a setting or switching off of the braking force at the individual wheel brakes at different times from one another. With such a procedure, a groaning of the brake in the range of low speeds is effectively prevented.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A brake system for a motor vehicle, the brake system comprising:
at least one brake actuation device for actuating wheel brakes formed as friction brakes; and
a control device for controlling actuation of the wheel brakes,
wherein, in a transition from driving at a vehicle speed to standing or from standing to accelerating to the vehicle speed, the control device at least one of:
(a) actuates the wheel brakes at different times from one another,
(b) energizes the wheel brakes at different times from one another with increasing actuation force,
(c) releases the wheel brakes at different times from one another, and
(d) energizes the wheel brakes at different times from one another with decreasing actuation force.

2. The brake system according to claim 1, wherein the wheel brakes, during a range of vehicle speed and when standing still, are controlled via the brake actuation device so that an essentially constant braking force is generated by each wheel brake when the wheel brakes are actuated to increase a braking force, said constant braking force allowing the vehicle to brake to a stop and, when the wheel brakes are actuated to decrease the braking force, allowing each wheel brake to be completely released without additional braking force being generated.

3. The brake system according to claim 1, wherein the control device controls the wheel brakes such that the wheel brakes are, individually or in pairs: (a) actuated at different times from one another, (b) energized at different times from one another with increasing actuation force, (c) released at different times from one another, or (d) energized at different times from one another with decreasing actuation force.

4. The brake system according to claim 1, wherein the control device includes an anti-locking braking system for the application of actuation force at different times.

5. The brake system according to claim 1, wherein the actuation force for the wheel brakes is applied by actuators driven by an electric motor.

6. The brake system according to claim 1, wherein the vehicle speed is a speed between 0 km/h and 10 km/h.

7. The brake system according to claim 6, wherein the vehicle speed is a speed between 0 km/h and 6 km/h.

8. The brake system according to claim 1, wherein the control device performs at least one of (a)-(d) depending on a coefficient of friction.

9. In a system having at least one brake actuation device for actuating wheel brakes formed as friction brakes and a control device for controlling actuation of the wheel brakes, a process for braking a motor vehicle, the process comprising the acts of:
recognizing, via the control device, a transition from driving at a vehicle speed to standing or from standing to accelerating to the vehicle speed; and
selecting, by the control device, at least one of the following to counteract brake groaning during the transition:
(a) actuating the wheel brakes at different times from one another,
(b) energizing the wheel brakes at different times from one another with increasing actuation force,
(c) releasing the wheel brakes at different times from one another, and
(d) energizing the wheel brakes at different times from one another with decreasing actuation force.

10. A process for braking in a motor vehicle, the process comprising the acts of:
recognizing a transition from driving at a vehicle speed to standing or from standing to accelerating to the vehicle speed; and
based on the determined transition, selecting at least one of the following:
(a) actuating the wheel brakes at different times from one another,
(b) energizing the wheel brakes at different times from one another with increasing actuation force,
(c) releasing the wheel brakes at different times from one another, and
(d) energizing the wheel brakes at different times from one another with decreasing actuation force.

11. The brake system according to claim 10, wherein the wheel brakes, during a range of vehicle speed and when standing still, are controlled so that an essentially constant braking force is generated by each wheel brake when the wheel brakes are actuated to increase a braking force, said constant braking force allowing the vehicle to brake to a stop and, when the wheel brakes are actuated to decrease the braking force, allowing each wheel brake to be completely released without additional braking force being generated.

12. The process according to claim 10, wherein the wheel brakes are, individually or in pairs, at least one of (a) actuated at different times from one another, (b) energized at different times from one another with increasing actuation force, (c) released at different times from one another, and (d) energized the wheel brakes at different times from one another with decreasing actuation force.

13. The process according to claim 10, wherein the vehicle speed is between 0 km/h and 10 km/h.

14. The process according to claim 13, wherein the vehicle speed is between 0 km/h and 6 km/h.

15. A process for braking a motor vehicle, the motor vehicle having wheel brakes and an actuation device for actuating the wheel brakes, the process comprising the acts of:
detecting an operation of the actuation device intended to release the wheel brakes; and
sequentially reducing braking pressures applied by each of the wheel brakes at successively increasing points in time, in response to the detected operation.

16. The process of claim 15, further comprising:
sequentially engaging each of the wheel brakes at different times, when a user manipulates the actuation device to increase braking pressure.
